(19) United States
(12) Patent Application Publication
(10) Pub. No.: US 2026/0349379 A1
(43) Pub. Date: Nov. 5, 2026

(54) IMAGE FORMING SYSTEM, CONTROL DEVICE, AND COMPUTER-READABLE RECORDING MEDIUM STORING CONTROL PROGRAM

(71) Applicant: Konica Minolta, Inc., Tokyo (JP)

(72) Inventors: Yumiko IZUMIYA, Tokyo (JP); Satoshi OGATA, Tokyo (JP); Hitoshi ASANO, Toyokawa-shi (JP); Tadayuki UEDA, Tokyo (JP); Hiroyuki MARUYAMA, Sagamihara-shi (JP)

(73) Assignee: Konica Minolta, Inc., Tokyo (JP)

(21) Appl. No.: 19/281,913

(22) Filed: Jul. 28, 2025

(30) Foreign Application Priority Data
Aug. 19, 2024 (JP) 2024-137572

(51) Int. Cl. G03G 15/00

(52) U.S. Cl. CPC G03G 15/5029; G03G 15/5016; G03G 15/5066; G03G 15/55

(57) ABSTRACT

This image forming system includes: a detector that detects sheet characteristic information corresponding to a characteristic of a sheet; a first output section that outputs at least one of an attribute of the sheet and a control parameter for forming an image on the sheet on the basis of the detected sheet characteristic information; and a second output section that outputs accuracy for reliability of an output result from the first output section.

### CROSS-REFERENCE TO RELATED APPLICATION

The entire disclosure of Japanese patent application No. 2024-137572, filed on Aug. 19, 2024, is incorporated herein by reference in its entirety.

### BACKGROUND OF THE INVENTION

### 1. Technical Field

The present invention relates to an image forming system, a control device, and a computer-readable recording medium storing a control program.

### 2. Description of Related Art

There is an image forming apparatus including a sensor that automatically detects characteristics of a sheet used for printing in order to generate a printed product with stable quality even when a wide variety of sheets are used. The image forming apparatus then sets control parameters for fixing, transfer, conveyance, etc. upon printing from the detected characteristics of the sheet (e.g., Japanese Unexamined Patent Application Publication No. 2022-089503).

### SUMMARY OF THE INVENTION

However, when the control parameter is estimated using, for example, a training model of machine learning for setting the control parameter from the characteristics of the sheet, the control parameter is not appropriately set in a case where a sheet having sheet characteristics largely deviated from training data is used. As a result, an image is formed with control parameters unsuitable for the sheet, which may lead to a conveyance failure or an image quality failure.

The present invention has been made in view of the above circumstances, and an object of the present invention is to prevent the occurrence of a conveyance failure or an image quality failure due to the use of an inappropriate control parameter.

To achieve at least one of the abovementioned objects, according to an aspect of the present invention, a system reflecting one aspect of the present inventions comprises the followings.

An image forming system including:
a detector that detects sheet characteristic information corresponding to a characteristic of a sheet;
a first output section that outputs at least one of an attribute of the sheet and a control parameter for image formation for forming an image on the sheet on the basis of the sheet characteristic information that has been detected; and
a second output section that outputs accuracy for reliability of an output result from the first output section.

### BRIEF DESCRIPTION OF THE DRAWINGS

The advantages and features provided by one or more embodiments of the present invention will be more fully understood from the following detailed description and the accompanying drawings. However, these are for purposes of illustration only and are not intended to limit the present invention.

FIG. 1 is a diagram illustrating a schematic configuration of an image forming system according to the present embodiment;

FIG. 2 is a schematic diagram illustrating a server communicably connected to a plurality of image forming systems;

FIG. 3 is a block diagram of the image forming system;

FIG. 4 is a schematic diagram illustrating a flow of data in the image forming system;

FIG. 5A is a block diagram of a sheet characteristic detection apparatus;

FIG. 5B is a diagram illustrating a schematic configuration of the sheet characteristic detection apparatus;

FIG. 6A is a diagram illustrating a schematic configuration of a size sensor;

FIG. 6B is a diagram illustrating a schematic configuration of a sheet thickness sensor;

FIG. 6C is a diagram illustrating a schematic configuration of a basis weight sensor;

FIG. 6D is a diagram illustrating a schematic configuration of a moisture percentage sensor;

FIG. 6E is a diagram illustrating a schematic configuration of a stiffness sensor;

FIG. 6F is a diagram illustrating a schematic configuration of a surface property sensor;

FIG. 6G is a diagram illustrating a schematic configuration of a resistance sensor;

FIG. 7 is a schematic diagram illustrating a method for determining control parameters;

FIG. 8 is a schematic diagram illustrating a method for determining control parameters;

FIG. 9 is a diagram illustrating sheet brand data;

FIG. 10 is a flowchart illustrating a process of registration to a sheet usage history database;

FIG. 11 is a diagram illustrating an example of sheet usage history data;

FIG. 12 is a flowchart illustrating a machine learning method for a training model 2;

FIG. 13 is a diagram illustrating an example of a training data set;

FIG. 14 is a flowchart illustrating printing processing according to a first embodiment;

FIG. 15 is a diagram illustrating an example of output of accuracy and a determination result thereof;

FIG. 16A is a flowchart illustrating printing processing according to a second embodiment; and

FIG. 16B is a flowchart illustrating printing processing according to the second embodiment.

### DETAILED DESCRIPTION

Embodiments of the present invention will be described below with reference to the accompanying drawings. It is to be noted that the scope of the present invention is not limited to the disclosed embodiments. Note that in the description of the drawings, the same components are denoted by the same reference signs, and redundant descriptions will not be repeated. In addition, dimensional ratios in the drawings are exaggerated for convenience of description and may be different from actual ratios. In the drawings, a top-bottom direction (vertical direction) is defined as a Z direction, a front direction and a rear direction of an image forming system or a sheet characteristic detection apparatus are defined as a Y direction, and a direction orthogonal to the Y and Z directions is defined as an X direction. The X direction is also referred to as a conveyance direction of a sheet. The Y direction is also referred to as a width direction. In the present embodiment, the sheet includes a printing sheet (hereinafter simply referred to as sheet) and various films. In particular, the sheet includes a sheet produced by using mechanical pulp and/or chemical pulp derived from plants. Examples of the types of sheets include coated glossy paper, coated matte paper, and uncoated paper such as plain paper and high-quality paper. Further, in the present embodiment, the sheet attribute includes a sheet type and a basis weight.

Furthermore, although an electrophotographic method using toner will be described below as an example of a method of an image forming apparatus, another method such as an inkjet method may be applied.

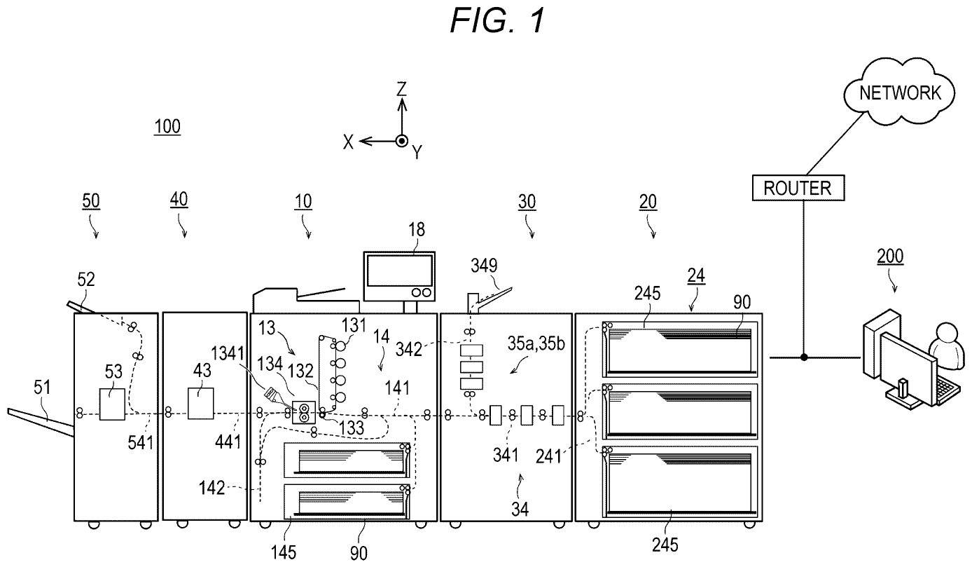

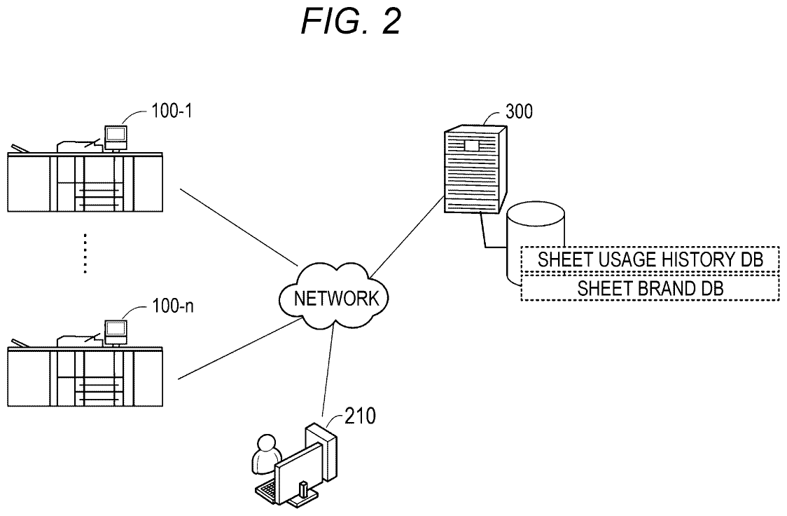

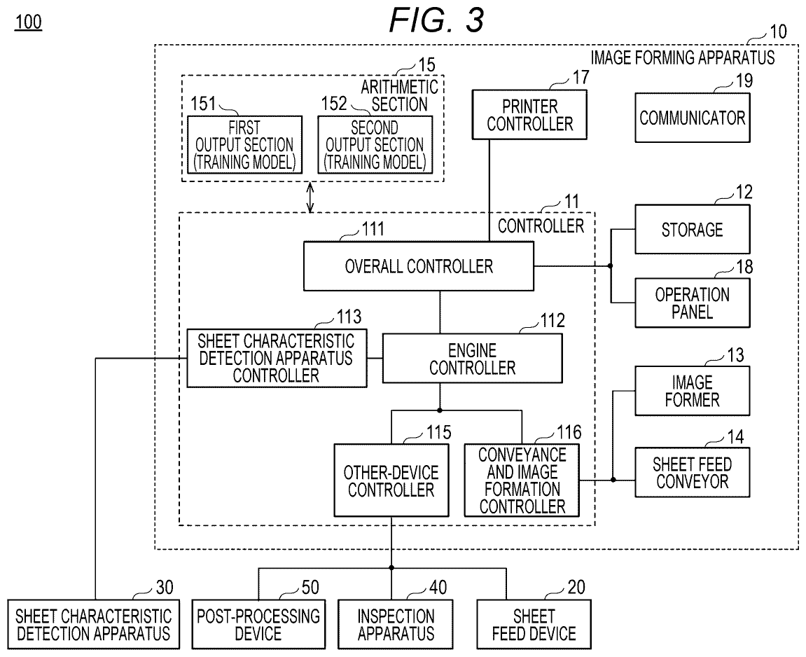

FIG. 1 is a diagram illustrating the schematic configuration of an image forming system 100 according to the present embodiment. FIG. 2 is a schematic diagram illustrating a management server 300 communicably connected to a plurality of image forming systems 100. FIG. 3 is a block diagram illustrating a hardware configuration of the image forming system 100. As illustrated in FIG. 1, the image forming system 100 includes an image forming apparatus 10, a sheet feed device 20, a sheet characteristic detection apparatus 30, an inspection apparatus 40, and a post-processing device 50, which are mechanically and electrically connected to each other. Further, the image forming system 100 is connected to a terminal device 200 such as a PC. Furthermore, the image forming system 100 and the terminal device 200 are connected to an external network via a router. The terminal device 200 is operated by, for example, an operator who uses the image forming system 100.

As illustrated in FIG. 2, a plurality of the image forming systems 100 (100-1 to 100-n) is connected to the management server 300 via a network. The terminal device 210 is a PC, a tablet terminal, a smartphone, or the like, and is used by an administrative user of a service staff management company or the like that maintains and manages the image forming apparatus 10 or the image forming system 100. These apparatuses and devices are communicatively connected to each other via a network. The management server 300 is an on-premise server located in a building where the image forming apparatus 10 is installed, or a cloud server using a commercial cloud service. The management server 300 functions as a database server and includes a sheet brand database and a sheet usage record database (hereinafter simply referred to as sheet brand DB and a usage record DB) (both will be described later).

The management server 300 collects usage record data of sheets and the like periodically sent from each image forming system 100 or image forming apparatus 10 (for example, upon completion of a job or daily), and accumulates the collected usage record data into the usage record DB. In addition, in the “sheet brand data” (also referred to as reference data or a media bank) stored in the sheet brand DB, characteristic data of a sheet brand used in the market is registered. The characteristic data of the sheet brand is used to identify the sheet brand using characteristic data of a sheet. In a case where a new sheet brand is used in the market, the administrative user measures sheet characteristic data and registers the measured sheet characteristic data in the sheet brand DB.

### (Image Forming Apparatus 10)

FIGS. 1 and 3 are referred to. The image forming apparatus 10 forms an image on a sheet 90 sent from the sheet characteristic detection apparatus 30 located on an upstream side. The image forming apparatus 10 includes a controller 11, a storage 12, an image former 13, a sheet feed conveyor 14, an arithmetic section 15, a printer controller 17, an operation panel 18, a communicator 19, and the like. These components are connected to each other via a signal line such as a bus for exchanging signals.

### (Controller 11)

The controller 11 includes a CPU, a ROM, a RAM, and the like. The controller 11 executes various kinds of processing by executing programs stored in the ROM and the storage 12 described later, and controls components of the apparatus and executes various kinds of calculation processing in accordance with the programs. The controller 11 functions as an overall controller 111, an engine controller 112, a sheet characteristic detection apparatus controller 113, an other-device controller 114, and a conveyance and image formation controller 116. The functions of these sub-controllers 111 to 116 will be described later.

### (Storage 12)

The storage 12 includes a ROM that stores various programs and various types of data in advance, a RAM that temporarily stores programs and data as a work area, and an auxiliary storage such as a hard disk that stores various programs and various types of data. In addition, the storage 12 stores sheet information regarding sheets stored in each sheet feed tray. The sheet information includes information regarding the brand, size (sheet width, sheet length), basis weight (weight), and type (plain paper, coated paper (gloss coated paper, matte coated paper), high-quality paper, rough paper, etc.) of the sheet.

### (Image Former 13)

The image former 13 forms an image by, for example, an electrophotographic method. The image former 13 includes writing sections and photosensitive drums respectively corresponding to basic colors of yellow (Y), magenta (M), cyan (C), and black (K) (not illustrated). The image former 13 also includes developing devices 131 each accommodating a two-component developer including toner of the corresponding color and a carrier as illustrated in FIG. 1. The image former 13 further includes an intermediate transfer belt 132, a secondary transferer 133, and a fixer 134. The toner images formed on the photosensitive drums by the developing devices 131 of the respective colors are superimposed on the intermediate transfer belt 132, and are transferred onto the conveyed sheet 90 in the secondary transferer 133. The toner image on the sheet 90 is fixed on the sheet 90 by being heated and pressed by the fixer 134 on the downstream side.

The fixer 134 includes a heater that is an upper component and contacts the toner image, a pressurizer that is a lower component, a non-contact temperature sensor that detects the temperature of the heater, and a separator 1341 (refer to FIG. 1). The heater may be composed of a single roller, or may adopt a fixing belt system and include a fixing belt and a plurality of inner rollers that hold the fixing belt. The separator 1341 is disposed in the vicinity of an exit of a fixing nip portion formed by pressure contact of the pressurizer with the heater. The separator 1341 helps the separation of the sheet from the fixing belt. The separator 1341 separates the sheet 90 from the fixing belt using an air separation method. The separator 1341 includes a fan (hereinafter, referred to as fixing separation fan) and a duct, and blows a predetermined volume of air to the leading end (leading end in the conveyance direction) of the sheet in accordance with the timing at which the sheet 90 passes through the fixing nip portion. The air volume of the fixing separation fan (fan rotation speed) is variably controlled by setting a control parameter.

### (Sheet Feed Conveyor 14)

The sheet feed conveyor 14 includes conveyance paths 141 and 142, a plurality of sheet feed trays 145, and the like. The conveyance path 141 includes a plurality of conveyance roller pairs provided along the conveyance path and a drive motor (not illustrated) that drives the conveyance roller pairs. The sheet feed conveyor 14 includes a delivery roller that delivers an uppermost sheet of a plurality of sheets 90 loaded and placed in the sheet feed tray 145, and delivers (feeds) the sheets 90 in the sheet feed tray to a conveyance path on the downstream side one by one. A first conveyance path 341 of the sheet characteristic detection apparatus 30 is connected to the upstream side of the conveyance path 141.

The sheet feed conveyor 14 conveys the sheet 90 fed from the sheet feed tray 145 and the like. The sheet 90 conveyed through the conveyance path 141 is subjected to image formation by the image former 13, and then ejected onto a sheet ejection tray 51 via the subsequent inspection apparatus 40 and the post-processing device 50. In double-sided printing in which an image is also formed on the back surface of the sheet 90, the sheet 90 on which an image has been formed on one side is conveyed to the conveyance path 142 for double-sided image formation in a lower portion of the apparatus body. The sheet 90 conveyed to the conveyance path 142 is turned over on a switchback path and then joins the conveyance path 141 for single-sided printing, and an image is again formed on the other side of the sheet 90 by the image former 13.

### (Arithmetic Section 15)

The arithmetic section 15 includes a first output section 151 and a second output section 152. The first output section 151 includes training models 1A, 1B, and 1C. The second output section includes a training model 2. Functions of these training models and a training method will be described later.

### Others

The printer controller 17 acquires a print job transmitted from a terminal device such as a personal computer (PC). Print data (image data) described in a page description language (PDL) format or a portable document format (PDF) included in the print job is rasterized by the printer controller 17 to be converted into image data for each page in a raster format. The converted image data is temporarily stored in a page memory. The image data from the page memory is read at a predetermined timing, stored in a buffer, and output as an exposure signal to the writing section for each main scanning line in synchronization with a writing timing.

The operation panel 18 includes a touch screen, a numeric keypad, a start button, a stop button, and the like. The operation panel 18 displays a state of the image forming apparatus 10 or the image forming system 100, and is used for input of settings and instructions from a user, as for the type of sheet placed in the sheet feed tray 145 or the like. Furthermore, in a case where the accuracy for the reliability of the first output section is low in processing that is described later, the operation panel 18 provides a warning display to the user or displays a screen for input and setting of control parameters.

The communicator 19 is an interface for communicating with other devices.

### (Sub-Controllers 111 to 116)

When receiving a print job, the overall controller 111 causes the engine controller 112 to execute the input print job on the basis of print job setting information about the print job. The print job is input in response to an instruction sent from the operation panel 18 or the terminal device 200 operated by the user.

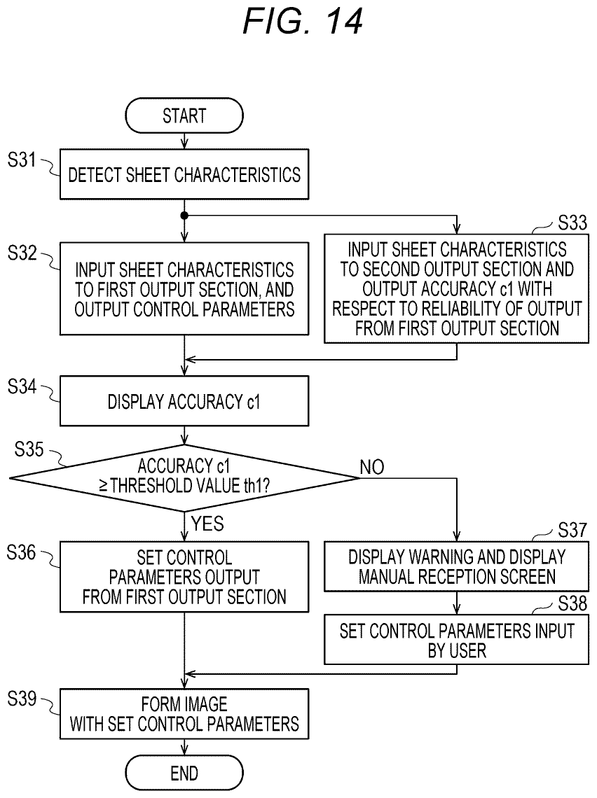

The engine controller 112 performs later-described printing processing illustrated in FIG. 14, etc. by controlling the other-device controller 115 and the conveyance and image formation controller 116.

In response to an execution instruction request from the engine controller 112, the sheet characteristic detection apparatus controller 113 controls the sheet characteristic detection apparatus 30 to execute measurement of sheet characteristics by various sensors included in the sheet characteristic detection apparatus 30.

The other-device controller 115 transmits, to the post-processing device 50, a sheet conveyance timing, information regarding setting of post-processing for a sheet to be conveyed, and the like. The other-device controller 115 also controls the sheet feed device 20. Specifically, the other-device controller 115 communicates with the sheet feed device 20 to transmit and receive a sheet feed tray to be used, a sheet conveyance timing, and the like. The other-device controller 115 also controls the inspection apparatus 40. Specifically, the other-device controller 115 communicates with the inspection apparatus 40 to perform the inspection using a reader 43.

The conveyance and image formation controller 116 controls sheet feed conveyance of the sheet 90 by controlling the sheet feed conveyor 14 (including drive motors for the conveyance paths 141 and 142, the fixer, and the like). The conveyance and image formation controller 116 also controls the image former 13 to control an image formation condition and an image formation timing according to a sheet position.

### (Sheet Feed Device 20)

As illustrated in FIG. 1, the sheet feed device 20 includes a sheet feed conveyor 24. The sheet feed conveyor 24 has a function equivalent to that of the above-described sheet feed conveyor 14. In addition, the sheet feed device 20 includes a controller, a storage, and a communicator (none of which are illustrated) in addition to the sheet feed conveyor 24, and these components are connected to each other via a signal line such as a bus for exchanging signals. The sheet feed conveyor 24 includes a plurality of sheet feed trays 245 and a conveyance path 241. The conveyance path 241 is connected to the conveyance path 341. The sheet 90 fed from each sheet feed tray 245 and conveyed through the conveyance path 241 is conveyed to the sheet characteristic detection apparatus 30 on the downstream side, and the sheet characteristic is measured or an image is formed by the image forming apparatus 10 on the further downstream side. The sheet feed conveyor 24 of the sheet feed device 20 feeds the uppermost sheet of a bundle of sheets accommodated in the sheet feed tray 245 one by one.

### (Inspection Apparatus 40)

The inspection apparatus 40 includes an inspection determiner constituted by a CPU or the like, and the reader 43. The reader 43 is a so-called scanner and generates read image data by reading an image on the sheet. The reader 43 is disposed on a conveyance path 441. The reader 43 may include two readers which are an upper reader and a lower reader provided across the conveyance path 441 and which have a common configuration so as to be able to read images on both sides of the sheet 90 conveyed on the conveyance path 441. The reader 43 reads an image on the sheet 90 formed by the image former 13 to generate a read image (read image data). The reader includes a sensor array, an optical system, and an LED light source. The sensor array, which includes a plurality of optical elements such as CCDs arranged in a line along the width direction (main scanning direction), is a color line sensor capable of reading the full width of the sheet 90 in the width direction. The optical system includes a plurality of mirrors and lenses. The light from the LED light source irradiates the surface of the sheet 90 passing through a reading position on the conveyance path 441. An image of the sheet 90 at the reading position is guided by the optical system and is thus formed on the sensor array.

The inspection determiner of the inspection apparatus 40 performs various kinds of inspections related to the image quality of a printed product by analyzing print data which serves as the source for printing and the read image data. In addition, the inspection determiner generates correspondence data between input and output by comparing and analyzing the pixel values of the print data and the pixel values of the read image data. For example, the inspection determiner generates the correspondence data between the image signal and the density or between the specific color based on the image signal and the output color. In addition, the inspection determiner evaluates failures such as the degree of bleed, stains, or white spots (spot-like defects) by comparing and analyzing the pixel values of the print data and the pixel values of the read image data.

### (Post-Processing Device 50)

The post-processing device 50 performs post-processing on the sheet 90 sent from the image forming apparatus 10 or ejects the sheet 90 according to the setting of the print job. The post-processing device 50 includes sheet ejection trays 51 and 52, a post-processor 53, and a conveyance path 541. In addition, the post-processing device 50 includes a controller, a storage, a conveyor, and a communicator (none of which are illustrated), and these components are connected to each other via a signal line such as a bus for exchanging signals. The sheet ejection trays 51 and 52 are selected according to the setting of the print job. For example, the sheet ejection tray 51 is used as a main tray to which a normal printed product is ejected, and the sheet ejection tray 52 is used as a sub-tray to which a sheet 90 having an image with an image quality failure is ejected. The sheet 90 determined to have an image quality failure by the inspection apparatus 40 is treated as waste sheet that is not used as a product. The waste sheet is usually reprinted. The conveyance path 541 is connected to the conveyance path 441 on the upstream side. The post-processor 53 performs at least one of stapling, punching, cutting, folding, or bookbinding on the sheet 90 on which an image has been formed.

### (Flow of Data in Image Forming System)

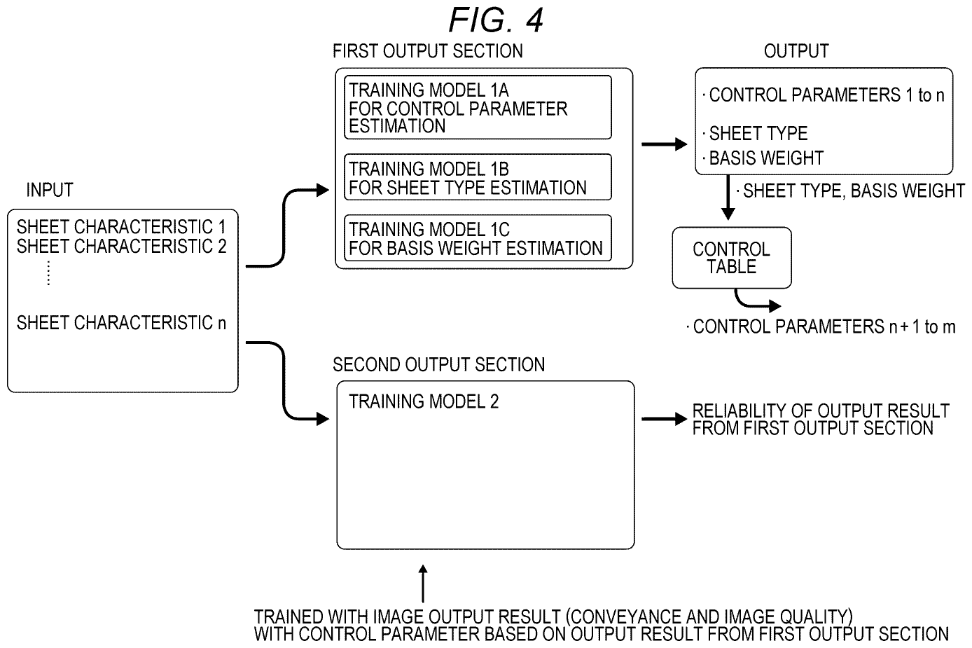

Here, an outline of the present embodiment will be described. The details will be described later with reference to FIG. 14 and the like, but the outline is as follows. FIG. 4 is a schematic diagram illustrating a flow of data in the image forming system 100. As illustrated in FIG. 4, sheet characteristics 1 to n are detected based on the detection by the sheet characteristic detection apparatus 30. The sheet characteristics 1 to n are input to the first output section 151 and the second output section 152. Control parameters 1 to n are output by a training model 1A for control parameter estimation in the first output section 151. In addition, the sheet type is output by a training model 1B for sheet type estimation. Furthermore, the basis weight is output by a training model 1C for basis weight estimation. Next, the control parameters n+1 to m are output using the output sheet type and basis weight and a control table.

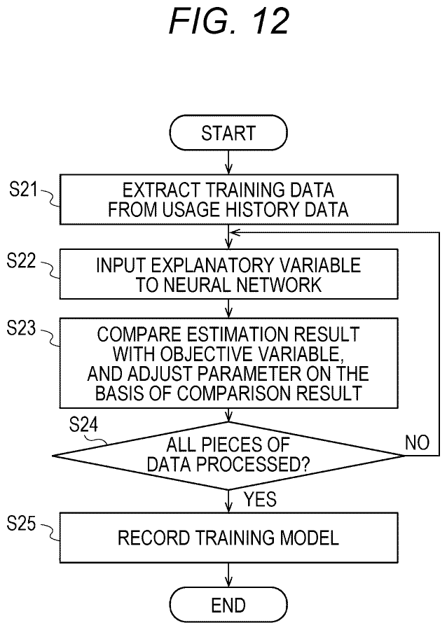

Furthermore, when the sheet characteristics 1 to n are input to a training model 2, the second output section 152 outputs the reliability (accuracy) of the output result from the first output section. The control parameters 1 to n and n+1 to m used for image formation, which are output results output from the first output section 151 are reflected when the accuracy output from the second output section 152 is high. On the other hand, if the accuracy is low, the control parameters 1 to n and n+1 to m are not reflected and are discarded. The training model 2 is obtained by machine learning using, as a training data set, an image output result (conveyance and image quality) with control parameters according to an output result from the first output section 151. The details of the machine learning will be described later (FIG. 12 described later).

### (Sheet Characteristic Detection Apparatus 30)

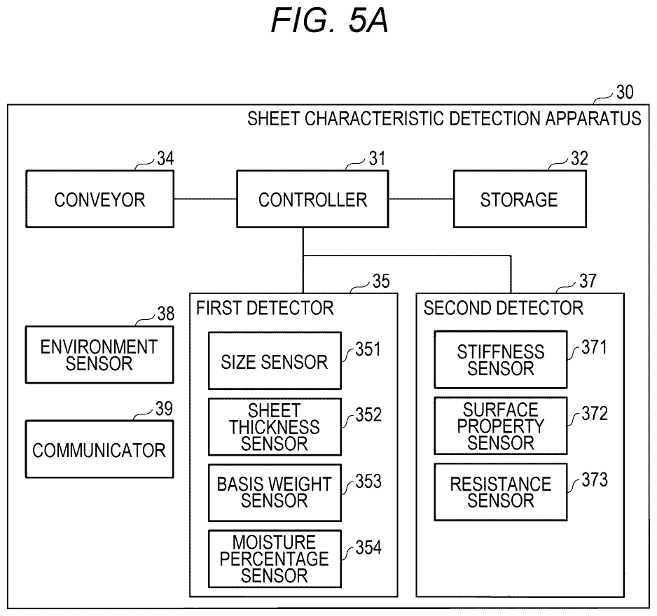

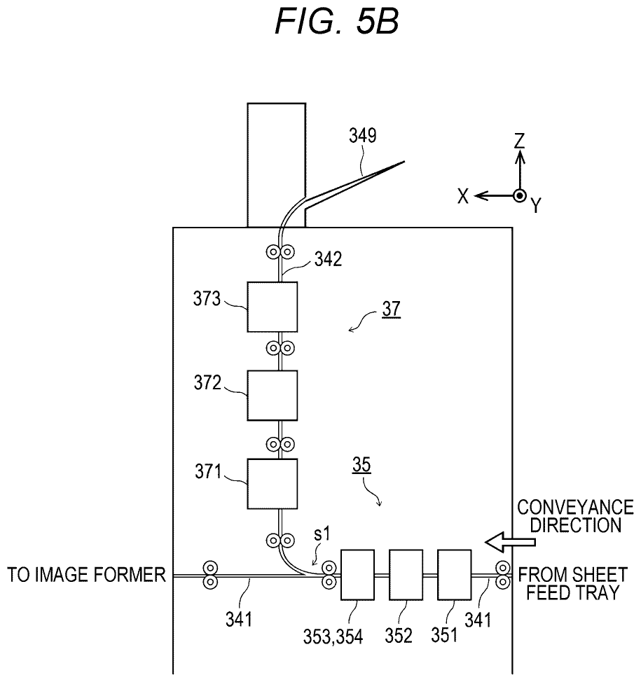

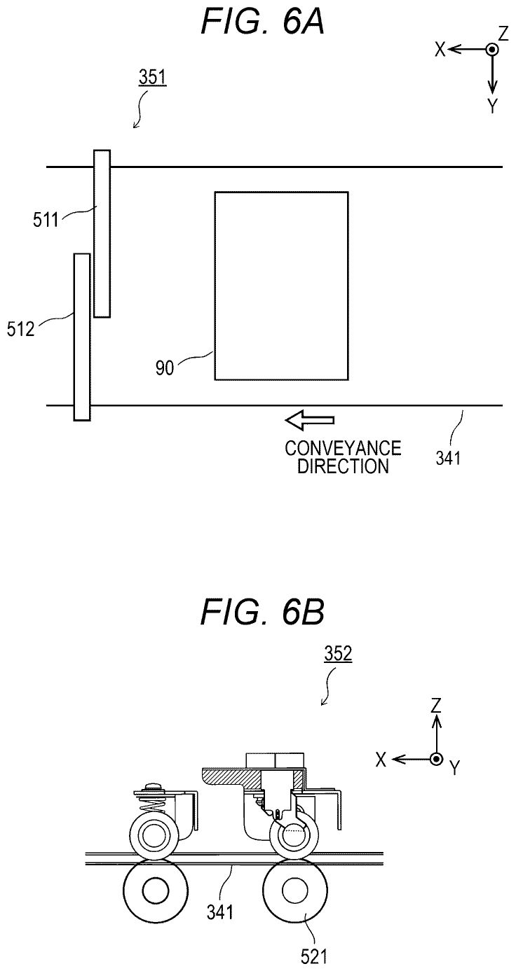

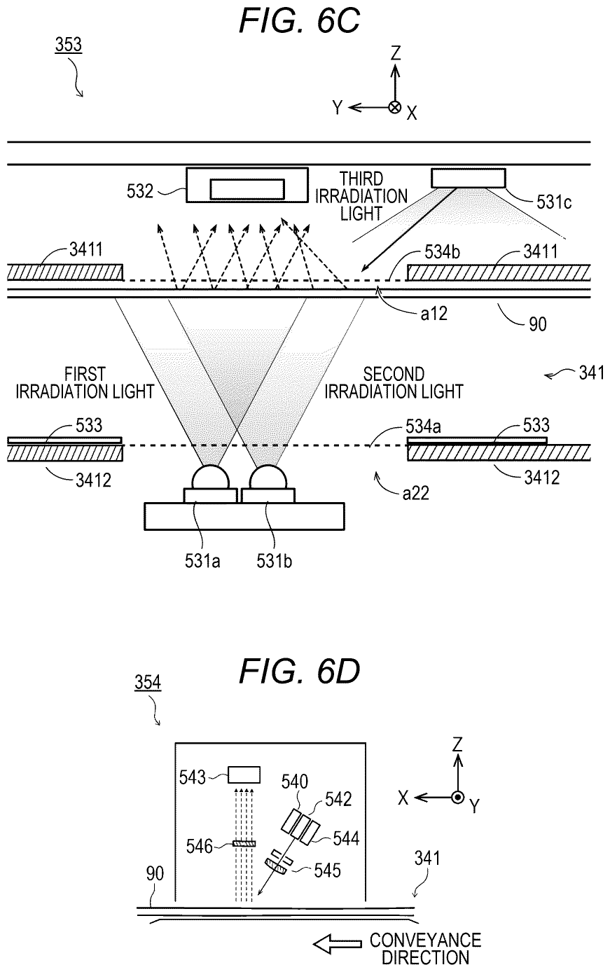

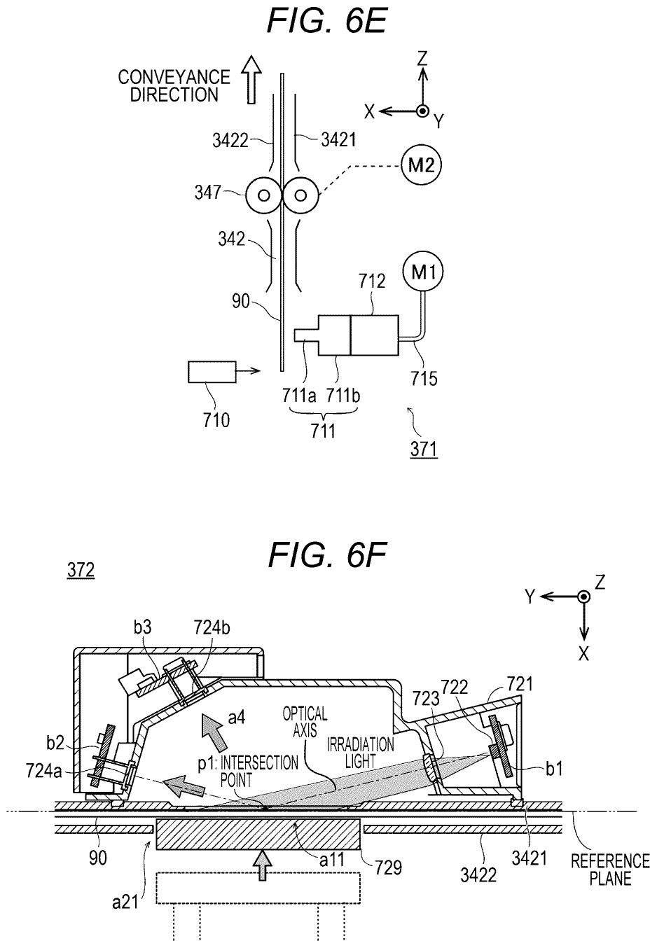

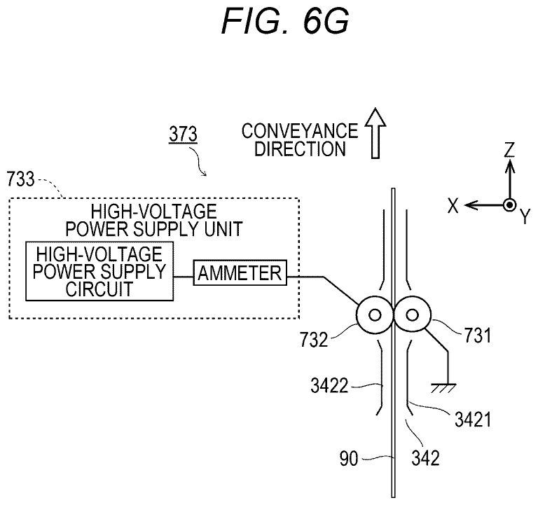

Next, the sheet characteristic detection apparatus 30 will be described with reference to FIGS. 5A to 6G. FIG. 5A is a block diagram of the sheet characteristic detection apparatus 30, and FIG. 5B is a diagram illustrating the schematic configuration of the sheet characteristic detection apparatus. The sheet characteristic detection apparatus 30 includes a controller 31, a storage 32, a conveyor 34, a first detector 35, a second detector 37, an environment sensor 38, and a communicator 39. The environment sensor 38 detects at least one of temperature or humidity in the apparatus body. The communicator 39 is an interface for communicating with other devices.

The first detector 35 includes a size sensor 351, a sheet thickness sensor 352, a basis weight sensor 353, and a moisture percentage sensor 354, as will be described later in detail. The second detector 37 includes a stiffness sensor 371, a surface property sensor 372, and a resistance sensor 373. Sheet characteristics 1 and 2 illustrated in FIG. 9 which will be described later are detected by the surface property sensor 372. Sheet characteristics 3, 4, 5, and 6 are detected by the sheet thickness sensor 352, the moisture percentage sensor 354, the stiffness sensor 371, and the resistance sensor 373, respectively. Sheet characteristics 7 to 12 are detected by the basis weight sensor 353. The sensors of the first detector 35 are disposed on the conveyance path 341 connected to a main conveyance path connected to the image former 13, and detect the respective characteristics while conveying the conveyed sheet 90.

Similarly to the controller 11 described above, the controller 31 includes a CPU and a memory. The controller 31 controls the operation of the first detector 35 and the second detector 37 to detect sheet characteristic information corresponding to the sheet characteristics of the sheet 90.

The storage 32 includes a ROM that stores various programs and various types of data in advance, a RAM that temporarily stores programs and data as a work area, and an auxiliary storage such as a hard disk that stores various programs and various types of data. The storage 32 also stores an environment correction table in which detection values of the environment sensor 38 are associated with correction values. The controller 31 corrects a detection result of each sensor of the first detector 35 and the second detector 37 in accordance with the detection values of the environment sensor 38 and the environment correction table.

The conveyor 34 includes a first conveyance path 341, a second conveyance path 342, and a purge tray 349 for ejecting the sheet 90 to be purged. The first and second conveyance paths 341 and 342 include a plurality of conveyance roller pairs provided along the conveyance paths and drive motors (not illustrated) that drive the conveyance roller pairs. The first conveyance path 341 is a main conveyance path, and has an upstream side connected to the conveyance path 241 of the sheet feed device 20 and a downstream side connected to the conveyance path 141 of the image forming apparatus 10. The second conveyance path 342 is branched from the first conveyance path 341 at a branch portion s1. In the second conveyance path 342, the sheet 90 to be purged to the purge tray 349 is conveyed without passing through the image former 13 (disposed on the conveyance path 141). The first conveyance path 341 extends in a substantially horizontal direction. At least a part of the second conveyance path 342 extends in a substantially vertical direction. In particular, in an area where the stiffness sensor 371 to be described later is disposed, the second conveyance path 342 extends in a substantially vertical direction, and the sheet is conveyed in an upward direction. Note that the second conveyance path 342 is not required to be entirely linear. As long as at least a measurement area of the stiffness sensor 371 in the second conveyance path 342 is straight, the other paths may be partially curved. For example, the second conveyance path 342 may be an S-shaped curved conveyance path as a whole.

### (First Detector 35)

The configuration examples of the size sensor 351, the sheet thickness sensor 352, the basis weight sensor 353, and the moisture percentage sensor 354 will be described below with reference to FIGS. 6A to 6D. As described above, these sensors 351 to 354 detect the sheet characteristic information corresponding to the size, the sheet thickness, the basis weight, and the moisture percentage while conveying the sheet 90 conveyed on the first conveyance path 341 without stopping the sheet 90. In particular, these sensors 351 to 354 detect the sheet characteristic information while conveying the sheet 90 at a conveyance speed during image formation (hereinafter, also referred to as a normal conveyance speed). In this manner, the sheet characteristic information of all the sheets 90 is detected without degrading the productivity.

### (Size Sensor 351)

The size sensor 351 optically detects the size (shape) of the sheet 90. The size sensor 351 includes, for example, one or two image sensors. FIG. 6A is a diagram illustrating a schematic configuration of the size sensor 351. In the example illustrated in FIG. 6A, the size sensor 351 includes two line sensors 511 and 512. Each of the line sensors 511 and 512 is an image sensor in which photoelectric conversion elements configured by a contact image sensor (CIS) or the like are arranged in one line or a plurality of lines, and reads a one-dimensional image. Each of the line sensors 511 and 512 includes optical elements such as light emitting elements or lens arrays arranged along the line of the photoelectric conversion elements. The light emitting elements emit light that is uniform in an extending direction of the line toward the sheet 90 on the first conveyance path 341. In the example illustrated in FIG. 6A, each of the line sensors 511 and 512 has a length of 200 mm to 300 mm in a longitudinal direction. The line sensors 511 and 512 are arranged adjacent to each other in the conveyance direction (X direction) so as to overlap each other in the width direction (Y direction). Accordingly, the line sensors 511 and 512 can read the sheet 90 of A3 plus size or the like, and thus, a full width of the conveyed sheet 90 is read. The sheet 90 convened at a predetermined conveyance speed is read by the line sensors 511 and 512, whereby read image data is generated. The controller 31 performs image processing on the obtained read image data for one sheet 90 to detect edges (positions of four sides or an outer shape) of the sheet 90 and detect the size (shape) of the sheet 90. The controller 31 may detect the shape and size of the sheet 90 by processing each of the two pieces of read image data obtained from the two sensors 511 and 512. Alternatively, the controller 31 may combine the two pieces of read image data into one piece of data and process the combined data to detect the shape and size of the sheet 90. FIG. 6A illustrates an example in which the two sensors 511 and 512 are disposed so as to overlap each other in the widthwise direction. On the other hand, one large sensor corresponding to the size of A3 plus sheet or the like may be used.

### (Sheet Thickness Sensor 352)

FIG. 6B is a diagram illustrating a schematic configuration of the sheet thickness sensor 352. The sheet thickness sensor 352 detects the thickness of the sheet 90 by mechanically measuring a displacement amount. When the sheet 90 is conveyed to a nip of the conveyance roller pair 521, the position of a shaft of a driven roller of the conveyance roller pair 521 is displaced in accordance with the thickness of the sheet 90. The thickness of the sheet 90 is measured by measuring the height of the displaced shaft. In the conveyance roller pair 521, the lower roller of the two rollers is a fixed driving roller (the shaft center is fixed), and the upper roller is a driven roller biased so as to be able to come into contact with and separate from the driving roller. The height of the upper roller is detected by a displacement sensor. The displacement sensor includes an actuator (detection lever) that is in contact with the shaft of the upper roller and an encoder that measures the rotation amount of the actuator. The sheet thickness sensor 352 outputs, for example, the thickness of a sheet (micron) as a measurement result of the sheet thickness.

### (Basis Weight Sensor 353)

FIG. 6C is a diagram illustrating a schematic configuration of the basis weight sensor 353. The basis weight sensor 353 that is a transmission-type or reflection-type optical sensor for detecting the basis weight of the sheet includes a light emitter and a light receiver, and detects the basis weight of the sheet 90 by measuring an attenuation amount (transmittance) of light transmitted through the sheet 90 and an amount of reflection light.

As illustrated in FIG. 6C, the basis weight sensor 353 includes a plurality of light emitters 531 and a single light receiver 532. The light emitters 531 include a first light emitter 531a, a second light emitter 531b, and a third light emitter 531c. First irradiation light, second irradiation light, and third irradiation light are emitted from the first, second, and third light emitters, respectively, to an irradiation area. The irradiation area (second irradiation area) is an inner area in an opening a12 when viewed in the Z direction. The opening a12 is provided in an upper guide plate 3411. A lower guide plate 3412 is also provided with an opening a22 at a position facing the opening a12. The openings a12 and a22 have the same shape, for example, a rectangular shape. In order to prevent a foreign substance such as paper dust from the sheet 90 passing through the first conveyance path 341 from adhering to the openings a12 and a22, transparent sheets 534a and 534b made of PET or the like that allow the first irradiation light, the second irradiation light, and the third irradiation light having different wavelengths to pass therethrough are attached at the openings a12 and a22.

The first light emitter 531a emits the first irradiation light having a first wavelength. The first wavelength is, for example, the wavelength of a near-infrared ray longer than the wavelength of a visible light ray. More specifically, the first wavelength includes, for example, a wavelength between 750 nm and 900 nm. The second light emitter 531b emits the second irradiation light having a second wavelength. The second wavelength is, for example, the wavelength of a blue light ray included in the visible light ray. More specifically, the second wavelength includes, for example, a wavelength between 400 nm and 470 nm. The first light emitter 531a and the second light emitter 531b are both disposed on the opposite side from the light receiver 532 with respect to the first conveyance path 341, and the third light emitter 531c is provided on the same side as the light receiver 532 and in the vicinity of the light receiver 532. The third light emitter 531c emits the third irradiation light having a third wavelength toward the irradiation area (the opening a12). The third wavelength is, for example, the wavelength of a green light ray included in the visible light ray. More specifically, the third wavelength includes, for example, a wavelength between 495 nm and 570 nm. The third wavelength is different from the first wavelength (for example, a wavelength between 750 nm and 900 nm) and the second wavelength (for example, a wavelength between 400 nm and 470 nm).

The third irradiation light is emitted toward the first conveyance path 341 between the upper and lower guide plates 3411 and 3412. A reflector 533 is provided inside the lower guide plate 3412 disposed near the first light emitter 531a and the second light emitter 531b. The reflector 533 is coated with, for example, green which is the same color as the third irradiation light, and reflects the third irradiation light. The reflector 533 does not reflect the first irradiation light (near-infrared ray) and the second irradiation light (blue light ray), which do not have the same color as the third irradiation light.

In the present embodiment, during the measurement, the controller 31 causes the first light emitter 531a and the second light emitter 531b to emit the first irradiation light and the second irradiation light at different timings by controlling the first light emitter 531a and the second light emitter 531b. The light receiver 532 receives the first irradiation light and the second irradiation light, detects the amounts of the first irradiation light and the second irradiation light, and outputs the detected amounts of the first irradiation light and the second irradiation light to the controller 31. Similarly, the controller 31 irradiates the sheet 90 conveyed to the position of the opening a12 with the first irradiation light and the second irradiation light. The light receiver 532 receives transmitted light of the first irradiation light and transmitted light of the second irradiation light (first transmitted light and second transmitted light), detects the amounts of the first transmitted light and the second transmitted light, and outputs, to the controller 31, the detected amount of the first transmitted light and the detected amount of the second transmitted light. That is, the light receiver 532 detects the first irradiation light and the second irradiation light when the sheet 90 is absent, and detects the first transmitted light and the second transmitted light when the sheet 90 is present at the opening a12.

Regarding the third light emitter 531c, similarly, the light receiver 532 detects first reflection light reflected by the reflector 533 when the sheet 90 is absent, and detects second reflection light reflected by the front surface of the sheet 90 when the sheet 90 is present at the opening a12.

The controller 31 calculates a first transmittance by dividing the amount of the first transmitted light by the amount of the first irradiation light. Similarly, the controller 31 calculates a second transmittance by dividing the amount of the second transmitted light by the amount of the second irradiation light. Then, the type of the sheet 90 may be identified on the basis of the first and second transmittances and a determination criterion stored in the storage 12.

The controller 31 may calculate a reflectance by dividing the amount of the second reflection light by the amount of the first reflection light in addition to the first transmittance and the second transmittance, and may identify the type of the sheet 90 in consideration of the reflectance. The third light emitter 531c and the reflector 533, which are provided in the present embodiment, may be omitted.

### (Moisture Percentage Sensor 354)

FIG. 6D is a diagram illustrating a schematic configuration of the moisture percentage sensor 354. The moisture percentage sensor 354 measures the moisture percentage of the sheet 90. Note that in the present embodiment, the moisture percentage sensor that measures a water content of the sheet as the sheet characteristic information will be described as an example. However, a moisture amount sensor that measures an amount of moisture contained in the sheet as the sheet characteristic information may be applied.

As illustrated in FIG. 6D, the moisture percentage sensor 354 includes a first light emitter 540, a second light emitter 542, a light receiver 543, a temperature detection sensor 544, lenses 545 and 546, and the like. The first light emitter 540 and the second light emitter 542 are light emitters that emit light toward a sheet.

The first light emitter 540 emits first near-infrared light (reference light) in a specific wavelength band toward a sheet P. Specific examples of the first light emitter 540 include a light emitting diode (LED). The first near-infrared light is light whose absorptance by the sheet P upon reflection on the sheet P is not affected by the moisture percentage of the sheet P. The light receiver 543 receives, via the lens 546, the first near-infrared light emitted from the first light emitter 540 and reflected on the sheet P via the lens 545. Then, the light receiver 543 outputs, to the controller 31, information about a first light reception amount which is a light reception amount of the reflected first near-infrared light. Specific examples of the light receiver 543 include a charge-coupled device (CCD) and a complementary metal-oxide-semiconductor (CMOS) image sensor.

The second light emitter 542 emits second near-infrared light in a specific wavelength band toward the sheet P. Specific examples of the second light emitter 542 include an LED. The second near-infrared light is light whose absorptance by the sheet P upon reflection on the sheet P varies with the moisture percentage of the sheet P. The light receiver 543 receives, via the lens 546, the second near-infrared light emitted from the second light emitter 542 and reflected on the sheet P via the lens 545. Then, the light receiver 543 outputs, to the controller 31, information about a second light reception amount which is a light reception amount of the reflected second near-infrared light.

That is, the first light emitter 540 and the second light emitter 542 emit light beams having wavelengths with different absorptance by moisture of the sheet. The second near-infrared light emitted from the second light emitter 542 is light having a wavelength that is absorbed more by the moisture of the sheet than the first near-infrared light (reference light) emitted from the first light emitter 540.

The controller 31 determines the moisture percentage of the sheet based on a ratio of the first light reception amount and the second light reception amount (a ratio of the output of the light receiver 543 to the first near-infrared light and the second near-infrared light). As the moisture percentage of the sheet is higher, an absorption amount of the second near-infrared light is larger, and thus the second light reception amount is smaller. Therefore, based on a relational expression or a table indicating a relationship between the moisture percentage of the sheet and the ratio of the first light reception amount and the second light reception amount, the controller 31 can associate the ratio of the first light reception amount and the second light reception amount with the moisture percentage of the sheet, and calculate the moisture percentage of the sheet from the ratio of the first light reception amount and the second light reception amount.

### (Second Detector 37)

The configuration examples of the stiffness sensor 371, the surface property sensor 372, and the resistance sensor 373 will be described below with reference to FIGS. 6E to 6G. These sensors 371 to 373 detect sheet characteristic information corresponding to the stiffness, the surface property, and the electric resistance while stopping the sheet 90 conveyed on the second conveyance path 342 or conveying the sheet 90 at a speed lower than the normal conveyance speed.

### (Stiffness Sensor 371)

FIG. 6E is a diagram illustrating a schematic configuration of the stiffness sensor 371. The stiffness sensor 371 detects the stiffness of the sheet 90 by mechanically measuring a displacement amount.

The stiffness sensor 371 is disposed vertically below the pair of rollers 347 that hold the stopped sheet 90. Rotational driving of the rollers 347 is controlled by a motor M2. The rollers 347 function as a conveyor for conveying the sheet 90 on the second conveyance path 342, and function as a holder when the stiffness is measured. The stiffness sensor 371 includes a sheet detection sensor 710, a presser 711, a pressing force detector 712, a support mechanism 715, and a motor M1. The motor M1 moves the support mechanism 715 in the horizontal direction (X direction). Accordingly, a tip of the presser 711 connected to the support mechanism 715 is located at a predetermined position in the X direction when the stiffness is measured. The sheet detection sensor 710 is a non-contact optical sensor and detects the presence or absence of a sheet, that is, the trailing end of the sheet at a detection position (indicated by an arrow in FIG. 6E).

When the stiffness is measured, the sheet 90 conveyed through the second conveyance path 342 is stopped so that the trailing end is located at the detection position of the sheet detection sensor 710 (or a position a predetermined amount past from the detection position). In a stopped state, the trailing end of the sheet 90 is free as illustrated in FIG. 6E. The presser 711 of the stiffness sensor 371 presses a lower end of the sheet 90 from a lateral direction. Specifically, the stiffness sensor 371 presses the lower end of the sheet 90 from the horizontal direction at a position higher than the detection position by a specific distance.

The presser 711 includes a blade 711a and a base 711b continuous with one end of the blade 711a in the horizontal direction Y. The blade 711a has a long plate-like shape that is long in the width direction (Y direction) so as to be able to contact the full width of the sheet 90 conveyed in the vertical direction (Z direction). The blade 711a comes into contact with the sheet 90 at a position (measurement point) vertically above and apart from the lower end of the sheet 90 by a specific distance. That is, the measurement point is located vertically below a portion of the sheet 90 held by the rollers 347.

The pressing force detector 712 is connected to a surface of the presser 711 reverse to a surface of the base 711b continuous with the blade 711a. The pressing force detector 712 detects a pressing force applied when the presser 711 is pressed in the horizontal direction by a repulsive force (rigidity) of the sheet 90 when the blade 711a of the presser 711, which is disposed at a predetermined position in the X direction by the motor M1 and the support mechanism 715, presses the sheet 90. That is, the pressing force detector 712 detects the pressing force applied when the sheet 90 is pressed and bent by the presser 711. As the pressing force detector 712, for example, a load cell (pressure sensor) can be adopted.

### (Surface Property Sensor 372)

FIG. 6F is a diagram illustrating a schematic configuration of the surface property sensor 372. The surface property sensor 372 is a reflection (specular reflection or diffuse reflection) optical sensor that detects the surface property of the sheet 90.

The surface property sensor 372 detects the surface property of the sheet 90 based on absolute values and ratios of intensities of the detected specular reflection light and scattered reflection light.

The upper guide plate 3421 located on the right side (upper side in FIG. 6F) with respect to the second conveyance path 342 is provided with an opening a11, and the lower guide plate 3422 located on the left side (lower side in FIG. 6F) with respect to the second conveyance path 342 is provided with an opening a21. The opening a11 has a substantially rectangular shape, and has a hole size of, for example, several tens of millimeters in length and width (Z direction and Y direction). The opening a21 is disposed at a position corresponding to the opening a11 and is slightly larger than the opening a11. A pressing plate 729 of a pressing mechanism is disposed in the opening a21, and moves from the lower side to the upper side in FIG. 6F to press and fix the sheet 90 to the upper guide plate 3421 at the time of measurement. When measurement is not performed, the opening a11 is closed by a shutter (not illustrated). The opening a21 is closed by the front surface of the pressing plate 729 that is slightly retracted.

The surface property sensor 372 emits light toward the stopped sheet 90 which is located on the reference plane of the opening a11 serving as an irradiation area, and receives specular reflection light and scattered reflection light from the irradiation area, thereby detecting the surface property. The reference plane corresponds to an inner surface of the upper guide plate 3421.

As illustrated in FIG. 6F, the surface property sensor 372 includes a housing 721, a light emitter 722, a collimating lens 723, and a plurality of light receivers 724a and 724b (hereinafter, also collectively referred to as a light receiver 724). The surface property sensor 372 detects, with the light receiver 724a, reflection light of the light emitted from the light emitter 722 and reflected from the front surface of the sheet 90, and detects scattered reflection light with the light receiver 724b or the like.

An arrangement angle of the light emitter 722 is set such that an incident angle of the irradiation light with respect to the reference plane is 75°. The incident angle of 75° is an angle used for measurement of white paper glossiness according to JIS, and is an angle at which the influence due to the color of an object to be measured is small. The reference plane is an imaginary plane including a lower surface of the upper guide plate 3421, and the front surface of the sheet 90 as an object to be measured is disposed on the reference plane at the time of measurement. The light emitter 722 is disposed on a substrate b1. The light emitter 722 includes a light emitting element serving as a light source, such as an LED, which emits light having a predetermined wavelength. Irradiation light emitted from the light source (point light source) is turned into substantially parallel light by the collimating lens 723 and is emitted to the irradiation area. In the present embodiment, the wavelength of the light source of the light emitter 722 is preferably within a range over 405 nm and below 525 nm, more preferably within a range of 445 nm or more and 500 nm or less, and most preferably around 465 nm. The irradiation area (first irradiation area) is an inner area in the opening a11 when viewed in a Z′ direction, and a center (optical axis) of the irradiation area and a reference plane parallel to an XY′ plane intersect at an intersection point p1. As the light emitter 722, a surface-emitting LED may be used, or a shell-shaped LED may be used. When a shell-shaped LED is used, a desired irradiation diameter (also referred to as a beam diameter) can be obtained by designing a lens suitable for directionality of the shell shape. The light emitter 722 and the light receiver 724 are disposed along the width direction (Y direction), that is, on the same XY plane, and the irradiation light from the light emitter 722 is along the width direction.

Each of the light receivers 724 includes a light receiving element such as a photodiode or a phototransistor, and includes a first light receiver 724a that receives specular reflection light from the irradiation area and one or a plurality of second light receivers 724b that receives diffuse reflection light from the irradiation area. The first light receiver 724a is disposed at a position of a reflection angle of 75° corresponding to the incident angle of 75° of the light emitter 722, and receives the specular reflection light. The second light receiver 724b can be disposed at a position of any reflection angle within a range of a reflection angle of 0° or more and less than 90° except for a position of 75°, and receives the diffuse reflection light. The second light receiver 724b is preferably arranged at a position of a reflection angle of 60°, 30°, or 0°, and more preferably arranged at two positions of 60° and 30° or one position of 60°. FIG. 6F illustrates an example in which the first light receiver 724a for receiving specular reflection light having a reflection angle of 75° and the second light receiver 724b for receiving diffuse reflection light having a reflection angle of 30° are disposed. In the drawing, the light receiver 724a is disposed on a substrate b2, and the light receiver 724b is disposed on a substrate b3. On paths of light to be received by the light receivers 724a and 724b, the housing 721 is provided with openings a3 and a4. The openings a3 and a4 have a similar structure. The openings a3 and a4 are, for example, circular slits of φ3 mm when viewed from the intersection point p1.

### (Resistance Sensor 373)

FIG. 6G is a diagram illustrating a schematic configuration of the resistance sensor 373. The resistance sensor 373 applies a high voltage between the front and back of the sheet 90 in a stopped state, and detects the electric resistance (volume electric resistance) of the sheet 90 on the basis of the value of a flowing current.

As illustrated in FIG. 6G, the resistance sensor 373 includes a detection roller 732, a counter roller 731, and a high-voltage power supply unit 733.

The detection roller 732 is disposed so as to be able to contact one side of the sheet 90. The detection roller 732 is made of, for example, an elastic material such as rubber having conductivity.

The counter roller 731 is disposed to face the detection roller 732 with the sheet 90 interposed therebetween. The counter roller 731 is disposed so as to be able to contact the other side of the sheet 90. The counter roller 731 includes, for example, a metal material. The counter roller 731 is grounded.

The high-voltage power supply unit 733 is a unit for applying a high voltage to the sheet 90. The high-voltage power supply unit 733 is electrically connected to the detection roller 732 and the counter roller 731. Thus, an electric circuit is formed by the detection roller 732, the counter roller 731, and the high-voltage power supply unit 733. The high-voltage power supply unit 733 includes an ammeter and a high-voltage power supply circuit. The ammeter is electrically connected to the detection roller 732. The ammeter detects a current flowing due to a voltage applied in the high-voltage power supply circuit.

The high-voltage power supply circuit is electrically connected to the detection roller 732 via the ammeter. The high-voltage power supply circuit can apply a high voltage. A voltage is applied to the detection roller 732 from the high-voltage power supply circuit via the ammeter. The high-voltage power supply circuit can apply a high voltage of 1k to 5 kV, for example. As a method for applying a voltage from the high-voltage power supply circuit, one type of voltage may be applied to the sheet 90, or a plurality of types of voltages may be controlled a plurality of times and applied to the sheet 90.

### (Method for Determining Control Parameter)

The controller 11 determines various control parameters according to a first example, a second example, or a method (FIG. 4 described above) obtained by combining the first and second examples described below.

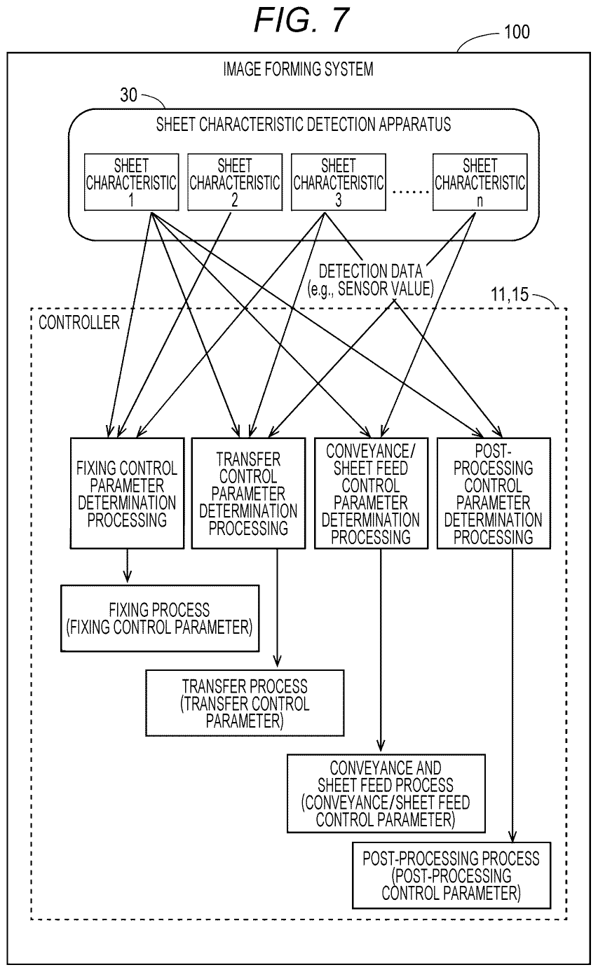

FIG. 7 is a block diagram illustrating a process of determining a control parameter from sheet characteristics in the first example. The controller 11 and the arithmetic section 15 determine each control parameter directly from the sheet characteristics. The sheet characteristics 1 to n (n represents any integer, the same applies hereafter) correspond to any of the sheet characteristics obtained from the respective sensors 351 to 354 and 371 to 373 of the above-described sheet characteristic detection apparatus 30. For example, the controller 11 determines fixing control parameters from the sheet characteristics 1, 2, and 3, and determines transfer control parameters from the sheet characteristics 1, 3, and n. Further, the controller 11 and the arithmetic section 15 determine conveyance/sheet feed control parameters from the sheet characteristics 1 and n, and determine post-processing control parameters from the sheet characteristics 1 and 3. For example, the fixing control parameters include the fixing temperature (fixing control temperature) of the fixer 134 and an air volume of the fixing separation fan. The transfer control parameters include a transfer current of the secondary transferer 133. The conveyance/sheet feed control parameters include a conveyance speed of the sheet 90. A trained model that has been trained by machine learning (training model 1A described above) is used for determining the control parameters.

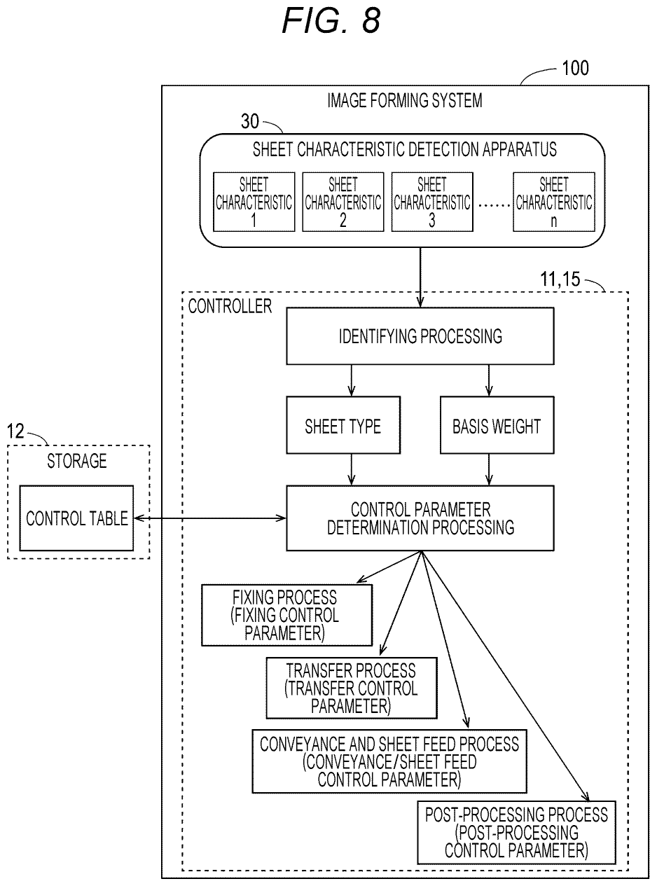

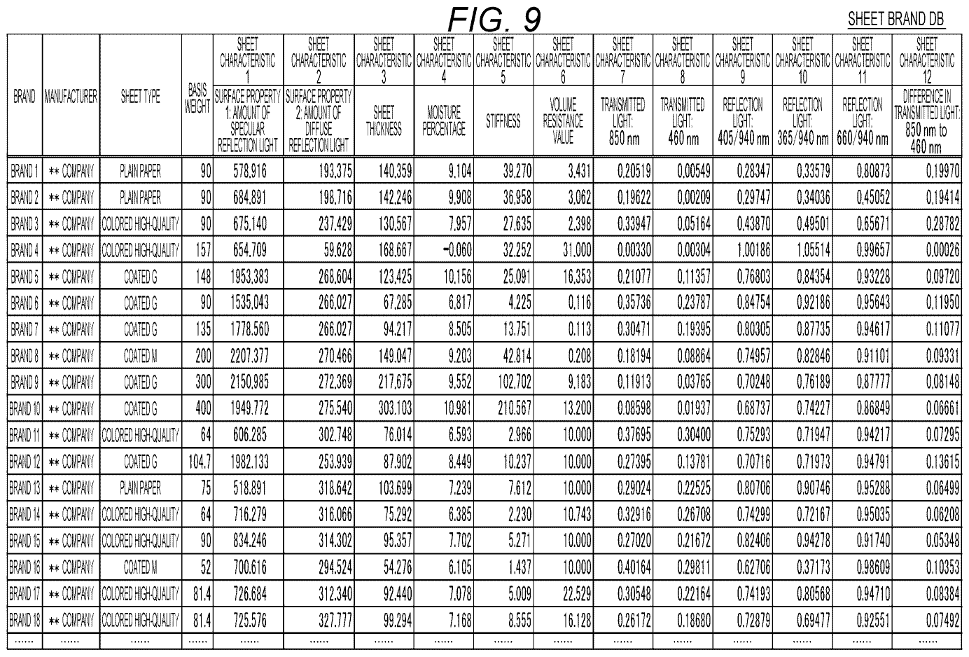

FIG. 8 is a block diagram illustrating a process of determining a control parameter from sheet characteristics in the second example. In the second example, the controller 11 and the arithmetic section 15 determine that the sheet characteristic is either a plurality of sheet types or a plurality of basis weights classified by identifying processing on the basis of sheet characteristics 1 to n. As compared with the first example described above, in the second example, the controller 11 and the arithmetic section 15 determine the control parameters after classifying the sheet characteristics into the sheet type and the basis weight. In the second example, the sheet characteristics 1 to n correspond to any of the sheet characteristics obtained from the sensors 351 to 354 and 371 to 373 of the above-described sheet characteristic detection apparatus 30. Then, a process of determining control parameters is performed based on the identified sheet type and basis weight. When performing the process of determining parameters, the controller 11 and the arithmetic section 15 refer to a correspondence table which is stored in the storage 12 in advance and in which control values of parameters for a fixing process, a transfer process, a conveyance and sheet feed process, and a post-processing process for each combination of sheet type and basis weight are described. A trained model that has been trained by machine learning (training model 1B, 1C described above) is used for determining the sheet type and the basis weight.

The controller 11 controls the fixing process by the fixer and the transfer process by the transferer of the image former 13 using the determined fixing and transfer control parameters. Further, the controller 11 controls the sheet feed conveyor 14 using the determined conveyance/sheet feed control parameters, and the controller of the sheet feed device 20 controls the conveyance and sheet feed process of the sheet feed device 20. Further, the controller of the post-processing device 50 controls the post-processing process using the determined post-processing control parameters.

### (Sheet Brand Database)

FIG. 9A is an example of brand data recorded in a sheet brand database. The brand data is managed by the management server 300 as described above, and is appropriately updated. The brand data is transmitted from the management server 300 to the image forming system 100 at a predetermined timing such as the time of update. Several hundred brands are registered in the brand data. The controller 11 normalizes the physical property values 1 to n of the characteristic data of a target sheet based on the maximum/minimum of physical property values 1 to n of the brand data. Then, the controller 11 calculates a sum of squared difference between the target sheet and a reference sheet (sheet registered as brand) for each physical property by trial, and calculates suitability for each record of the brand data from the magnitude of the difference. For example, using the following Expression (1), the controller 11 calculates the root mean square errors (RMSE) for the plurality of records and calculates a degree of matching f1 on the basis of the calculated RMSE. Then, the sheet brand having the highest degree of matching is adopted as a determination result.

[Mathematical Expression 1]

Degree of matching f1=1−RMSE Expression (1)

$$RMSE = \sqrt{\frac{1}{n} {\sum }_{i = 1}^{n} {( {S}_{i} - {Sd}_{i} )}^{2}} \text{?} \text{?} \text{?} \text{?} \qquad Expression ( 2 )$$

Here, Sᵢ is the measurement and detection data of the sheet characteristics, and Sdᵢ is sheet characteristic data registered in the database. n is the number of sheet characteristic data.

### (Sheet Usage History Data)

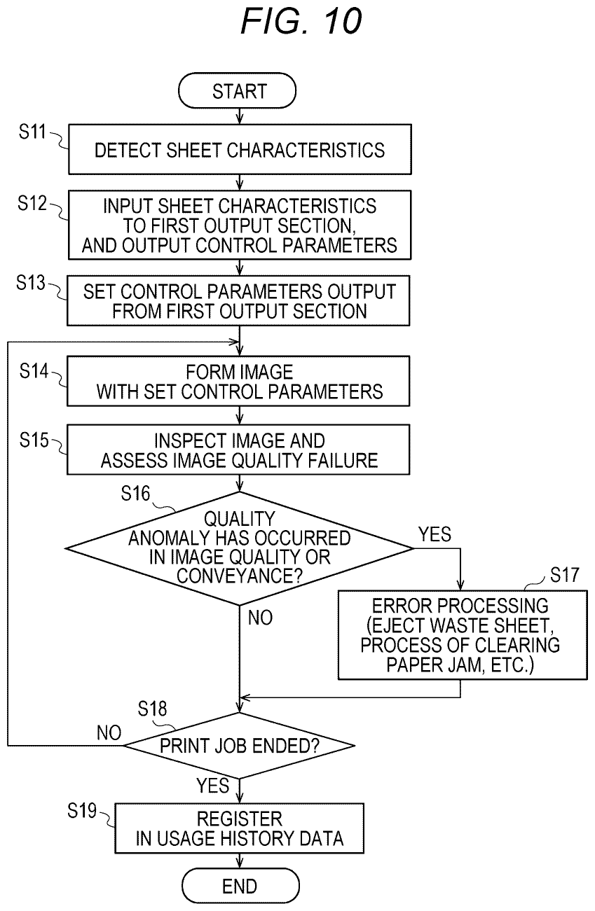

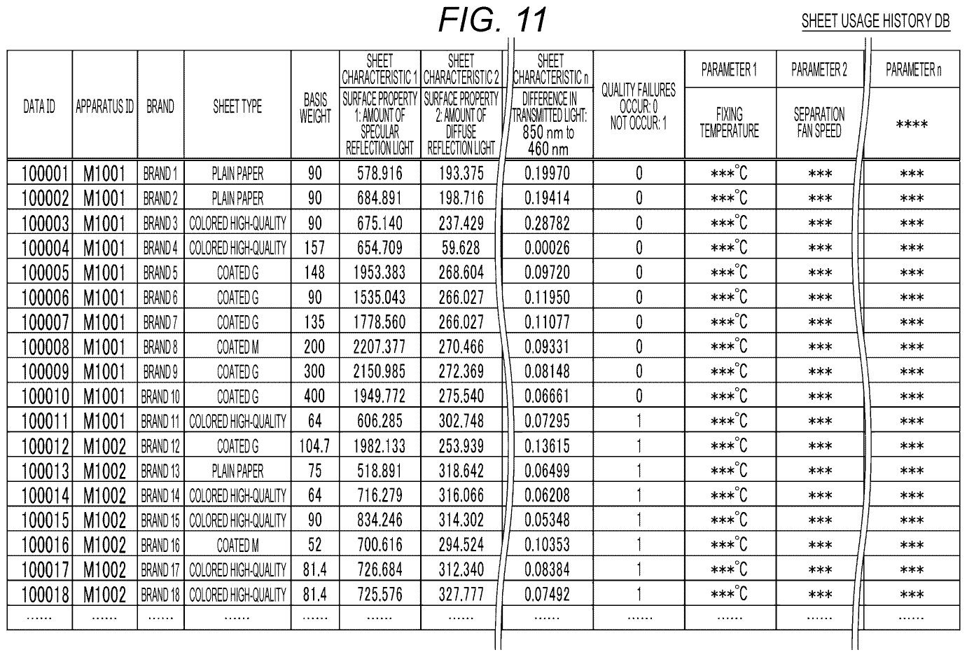

Next, the sheet usage history data and processing of accumulating the sheet usage history data will be described with reference to FIGS. 10 and 11. FIG. 10 is a flowchart illustrating a process of registration to the sheet usage history database. FIG. 11 is a diagram illustrating an example of the sheet usage history data.

### (Step S11)

When executing a print job, the image forming system 100 detects the sheet characteristics of the sheet 90 to be used by the sheet characteristic detection apparatus 30. Sheet characteristics 1 to n are obtained by the detection.

### (Step S12 and S13)

The sheet characteristics 1 to n acquired in step S11 are input to the first output section 151, and control parameters are output from the first output section 151. Then, the control parameters 1 to n output from the first output section 151 of the arithmetic section 15 are set as the control parameters 1 to n used for image formation by the image forming apparatus 10.

### (Steps S14 and S15)

The image forming apparatus 10 forms an image on the sheet 90 with the set control parameters. The inspection apparatus 40 performs various inspections related to image quality on read image data obtained by reading an image of the sheet 90 on which the image is formed by the reader 43, and assesses quality failures related to a plurality of quality items.

### (Step S16)

When it is assessed in step S15 that the image has a quality anomaly, or that a quality anomaly regarding conveyance such as a jam of the sheet 90 has occurred, the controller 11 advances the processing to step S17.

### (Step S17)

The image forming system 100 performs error processing for the quality anomaly that has occurred. For example, when the image has a quality anomaly, the controller 11 provides an error display on the operation panel 18 and causes the sheet 90 having the quality anomaly to be ejected to the sheet ejection tray 52 as waste sheet. In addition, in a case where a conveyance quality anomaly has occurred, the controller 11 displays a message indicating the occurrence of a conveyance jam or a warning to prompt the user to clear the conveyance jam on the operation panel 18. The user removes the sheet 90 that causes the conveyance jam.

### (Step S18)

When the print job has not been completed (NO), the controller 11 repeats the processes of step S14 and the subsequent steps, and when the print job has been completed (YES), the controller 11 proceeds to step S19.

### (Step S19)

The image forming system 100 transmits the sheet usage history data to the management server 300. The sheet usage history data includes, as the results of processes of steps S11 to S18, IDs of apparatuses that have performed the steps, the number of printed sheets, sheet characteristics, control parameters 1 to n, and information regarding the quality failure related to image quality and conveyance quality. For example, the quality failure includes whether or not a quality failure has occurred and the number of sheets on which the quality failure has occurred (the number of printed sheets without jamming, the number of jammed sheets, and the like). FIG. 11 is an example of sheet usage history data accumulated in the sheet usage history DB in the management server 300 by such processing.

### (Machine Learning)

Subsequently, machine learning for each training model will be described. A learner can generate a training model by a training method using a neural network formed by combining perceptrons. Note that the training method is not limited thereto, and various methods can be used as long as they are supervised learning. For example, random forest, a support vector machine (SVM), boosting, a Bayesian (Bayesian) network linear discriminant method, a non-linear discriminant method, or the like can be applied. Furthermore, as the learner, a standalone high-performance computer that uses processors, such as a CPU and a graphics processing unit (GPU), or a cloud computer can be used. For example, the management server 300 functions as the learner. Furthermore, the management server 300 can be trained by machine learning using, as training data, the sheet usage history data aggregated from the image forming systems 100 (or the image forming apparatuses 10).

### (Training Models 1A to 1C)

The training model 1A for control parameter estimation used by the first output section 151 is generated by machine learning using, as training data, a training data set that uses a plurality of pieces of sheet characteristic data (sheet characteristics 1 to n) as inputs and a plurality of control parameters as ground truth labels. For example, the sheet usage history data in which the quality failure does not occur can be used as the training data set.

The training model 1B for sheet type estimation used by the first output section 151 is generated by machine learning using a training data set that uses the sheet characteristic data (sheet characteristics 1 to n) as inputs and sheet type information set by the user as ground truth labels.

The training model 1C for basis weight estimation used by the first output section 151 is generated by machine learning using a training data set that uses the sheet characteristic data (sheet characteristics 1 to n) as inputs and basis weight information set by the user as ground truth labels.

### (Machine Learning for Training Model 2)

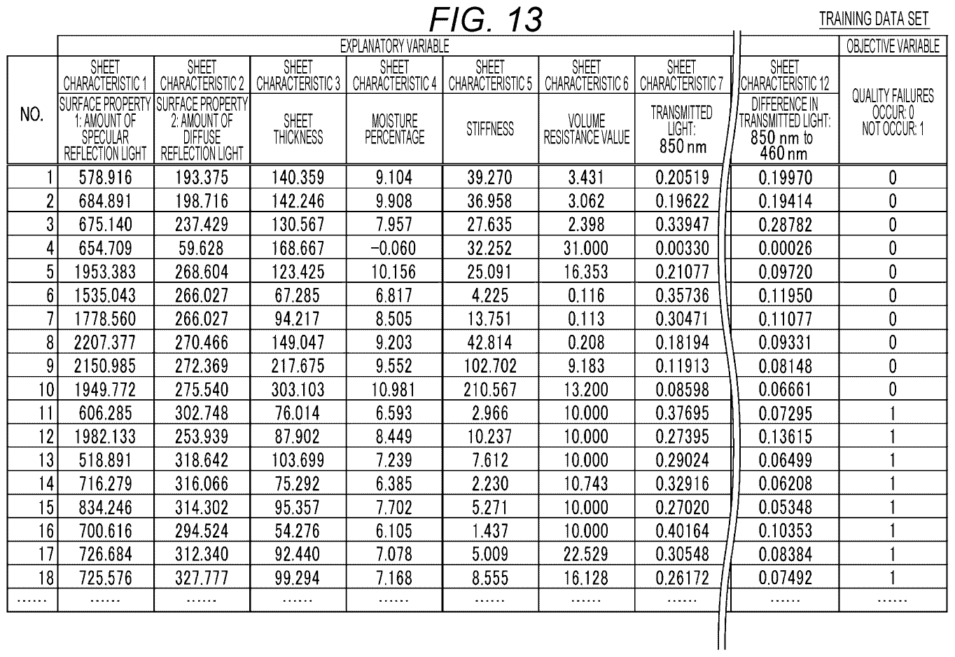

Machine learning for the training model 2 for assessing the accuracy (also referred to as reliability or probability) used in the second output section 152 will be described with reference to FIGS. 12 and 13. FIG. 12 is a flowchart illustrating a machine learning method for the training model 2 used in the second output section 152. For example, the machine learning illustrated in FIG. 12 is executed by the management server 300 functioning as a learner. FIG. 13 is a diagram illustrating an example of a training data set.

### (Step S21)

The controller 11 extracts data from the sheet usage history data as illustrated in FIG. 11, and generates a training data set. FIG. 13 is an example of such a training data set. The training data set includes sheet characteristic data (sheet characteristics 1 to n) as inputs (explanatory variables) and quality information (indicating whether or not a failure occurs) that is a ground truth label (objective variable). The quality information includes information regarding the image quality and/or the conveyance quality as described above.

### (Steps S22 and S23)

The explanatory variable is input to the neural network of the learner, the obtained estimation result is compared with the objective variable (ground truth label), and the parameter is adjusted on the basis of the comparison result.

### (Steps S24 and S25)

The processes of steps S22 and S23 are performed on all pieces of data in the training sample data set. When the training is finished using all pieces of data, the training model 2 is updated and stored, and the processing ends.

### Printing Processing in First Embodiment

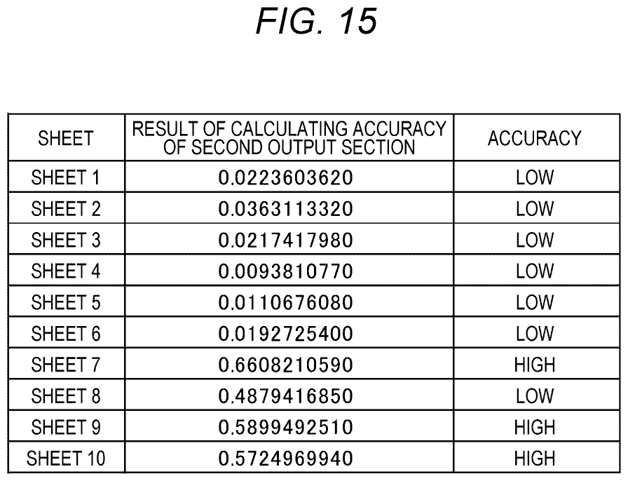

Next, printing processing using the training models described above will be described with reference to FIGS. 14 and 15. FIG. 14 is a flowchart illustrating printing processing according to the first embodiment.

### (Step S31)

When executing a print job, the image forming system 100 detects the sheet characteristics of the sheet 90 to be used by the sheet characteristic detection apparatus 30. Sheet characteristics 1 to n are obtained by the detection.

### (Step S32)

The sheet characteristics obtained in step S31 are input to the first output section 151 (training models 1A to 1C) of the arithmetic section 15, and thus the control parameters are obtained as outputs.

### (Step S33)

The sheet characteristics obtained in step S31 are input to the second output section 152 (training model 2) of the arithmetic section 15, and thus accuracy c1 is obtained as an output. The accuracy c1 can take a value within a range of 0 to 1.

### (Step S34)

The controller 11 notifies the user of the accuracy c1 obtained in step S33. For example, the controller 11 displays the accuracy c1 on the operation panel 18.

### (Steps S35 and S36)

The controller 11 assesses whether or not the accuracy c1 obtained in step S33 is equal to or greater than a predetermined threshold value th1. For example, the threshold value th1 is set to 0.50. FIG. 15 is a table illustrating an example of an accuracy calculation result and an assessment result thereof for each sheet. When the accuracy c1 is greater than or equal to the threshold value th1, the processing proceeds to step S36. In this case, the controller 11 assesses that the reliability of the output result from the first output section 151 is high, and thus, employs the control parameter output from the first output section 151 and sets the employed control parameter as a control parameter of the image forming apparatus 10 (step S36).

On the other hand, when the accuracy c1 is less than the threshold value th1, the processing proceeds to step S37. In this case, the controller 11 assesses that the reliability of the output result from the first output section 151 is low, and thus does not employ the control parameter output from the first output section 151.

### (Step S37)

Here, the controller 11 displays a warning indicating that the reliability is low on the operation panel 18. The operation panel 18 also displays a manual reception screen for receiving an input of a control parameter by the user. For example, in a case where the sheet 90 to be used for the print job is a sheet having sheet characteristics deviated from those of a sheet which has been used in the past, the accuracy c1 is assessed to be low, and such a warning is displayed. The user manually inputs appropriate control parameters for such a sheet, and causes the image forming system to form an image with the input control parameters.

### (Step S38)

Upon receiving setting of a control parameter from the user, the controller 11 sets the received setting to the control parameter of the image forming apparatus 10. In addition, in a case where there is no input within a predetermined time, or in a case where an instruction to stop printing is received, the image formation is stopped.

### (Step S39)

The controller performs image formation on the sheet 90 according to the control parameters set in step S36 or step S38, and ends the processing (END).

As described above, the image forming system according to the first embodiment includes a detector that detects sheet characteristic information corresponding to the characteristics of a sheet, a first output section that outputs at least one of an attribute of the sheet and a control parameter for forming an image on the sheet on the basis of the detected sheet characteristic information, and a second output section that outputs an accuracy for the reliability of the output result from the first output section. Thus, it is possible to prevent the occurrence of a conveyance failure or an image quality failure due to the use of an inappropriate control parameter.

### Printing Processing in Second Embodiment

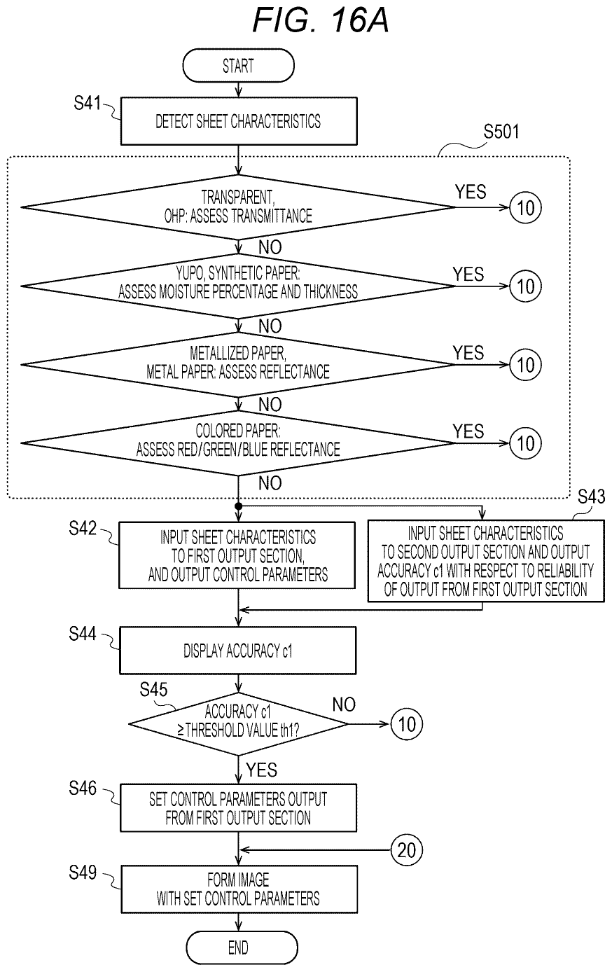

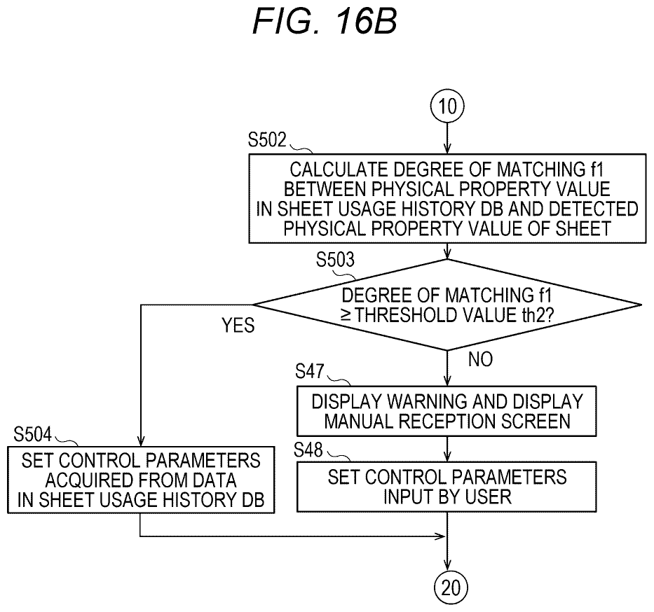

Next, printing processing executed by an image forming system 100 according to the second embodiment will be described with reference to FIGS. 16A and 16B. FIG. 16A is a flowchart illustrating printing processing according to the second embodiment. FIG. 16B is a flowchart illustrating processing to be executed subsequent to FIG. 16A. In the flowchart illustrated in FIGS. 16A and 16B, processes of steps S41 to S49 are the same as the processes of steps S31 to S39 of the flowchart illustrated in FIG. 14, respectively, and thus the description thereof will be omitted as appropriate. In FIGS. 16A and 16B, steps S501 to S504 are processes different from the flowchart of FIG. 14.

### (Steps S41 and S42)

When executing a print job, the image forming system 100 detects the sheet characteristics of the sheet 90 to be used by the sheet characteristic detection apparatus 30. Sheet characteristics 1 to n are obtained by the detection. Furthermore, control parameters are output from the first output section 151.

### (Step S501)

Here, processing for excluding a special sheet is performed.

The controller 11 assesses the transmittance from the sheet characteristics, and when the transmittance is higher than a predetermined threshold value, the controller 11 assesses that the sheet is a transparent medium such as an OHP sheet.

In addition, the controller 11 assesses the moisture percentage and the sheet thickness from the sheet characteristics, and when the moisture percentage is lower than a predetermined threshold value and the sheet thickness is greater than a predetermined threshold value, the controller 11 assesses that the sheet is synthetic paper such as YUPO paper.

When the reflectance is higher than a predetermined threshold value from the sheet characteristics, the controller 11 assesses that the sheet is metallized paper or metal paper obtained by depositing metal such as aluminum on the surface.

In addition, when the reflectance obtained by emitting light of a specific wavelength corresponding to red, green, or blue is higher than that of another wavelength from the sheet characteristics, the controller 11 assesses that the sheet is colored paper of red, green, or blue. In the case of such a special sheet, some sheet characteristics greatly deviate from normal ranges, so that the output from the first output section 151 is not used.

### (Step S502)

FIG. 16B is referred to. When it is assessed in step S501 that the sheet is a special sheet by any one of the assessments, or when it is assessed in step S45 that the accuracy c1 is less than the threshold value th1, the process of step S502 is performed.

In step S502, the controller 11 calculates a degree of matching f1 between the sheet characteristic in each datum recorded in the sheet usage history data in the sheet usage history DB and the sheet characteristic detected in step S41. The degree of matching is calculated using Expression (1) described above.

### (Step S503)

The data having the highest degree of matching f1 is extracted from the sheet usage history data, and when the degree of matching f1 of the extracted data is equal to or greater than a threshold value th2, the processing proceeds to step S504. On the other hand, when there is no data with a degree of matching f1 equal to or greater than the threshold value th2 in the sheet usage history DB, the processing proceeds to step S47. In this case, as in step S37 and subsequent steps of the first embodiment, the image forming system 100 displays a warning and then receives an input of a control parameter setting from the user.

### (Step S504)

The controller 11 selects a sheet usage history data item having a degree of matching f1 that is equal to or greater than the threshold value th2 and that is the highest from the sheet usage history DB, and acquires the control parameter used in this data item. For example, in the example illustrated in FIG. 11, when record data 18 (data ID:100018) is usage history data having a degree of matching f1 that is equal to or greater than the threshold value th2 and that is the highest, the parameters 1 to n used at that time are acquired. In the case of extraction from the usage history data, the usage history data in which the occurrence of the quality failure (“0” zero) is recorded is not used.

Thereafter, the processing proceeds to step S49, and image formation is performed with the control parameters set in step S504.

As described above, in the second embodiment, when the output result from the first output section is not reflected, the controller refers to the sheet usage record database, selects usage history data on the basis of the degree of matching with the detected sheet characteristic information, and sets a control parameter for image formation using the control parameter stored in the selected usage history data. With this configuration, it is possible to easily set an appropriate control parameter by referring to the control parameter used in the data that has been used in the past.

The terminal device 200 illustrated in FIG. 1 may be a component of the image forming system 100. In this case, the terminal device 200 functions as a control device. Furthermore, the controller and the communicator of the terminal device 200 function as an acquirer. The terminal device 200 may have functions of the first and second output sections of the arithmetic section 15. For example, in the processing illustrated in FIG. 14, the terminal device 200 performs the processes of the first and second output sections in steps S32 and S33, whereby the processing in FIG. 14 is performed by the controller of the terminal device 200 and the controller 11 in cooperation.

In addition, the means and method for performing various kinds of processing in the image forming system 100 according to the above-described embodiments can be implemented by either a dedicated hardware circuit or a programmed computer. The program may be provided by, for example, a computer-readable recording medium such as a USB memory or a digital versatile disc (DVD)-ROM, or may be provided online via a network such as the Internet. In this case, the program recorded on the computer-readable recording medium is usually transferred to and stored in a storage such as a hard disk. The above program may be offered as standalone application software or may be incorporated, as a function of an apparatus, into software for the apparatus.

While the embodiments of the present invention have been described and illustrated in detail, the disclosed embodiments have been created for purposes of illustration and example only, and not limitation. The scope of the present invention is to be interpreted by the wording of the appended claims.

What is claimed is:

1. An image forming system comprising:
a detector that detects sheet characteristic information corresponding to a characteristic of a sheet;
a first output section that outputs at least one of an attribute of the sheet and a control parameter for image formation for forming an image on the sheet on the basis of the sheet characteristic information that has been detected; and
a second output section that outputs accuracy for reliability of an output result from the first output section.

2. The image forming system according to claim 1, wherein the second output section outputs the accuracy on the basis of the sheet characteristic information that has been detected.

3. The image forming system according to claim 1, further comprising a controller that determines, based on the accuracy output from the second output section, whether to use the output result from the first output section.

4. The image forming system according to claim 3, wherein, when the accuracy is equal to or greater than a threshold value, the controller sets a control parameter for the image formation on the basis of the output result from the first output section.

5. The image forming system according to claim 3, wherein, when the accuracy is lower than a threshold value, the output result from the first output section is not reflected in the image formation.

6. The image forming system according to claim 3, wherein, when the accuracy is lower than a threshold value, image formation based on the output result from the first output section is not performed.

7. The image forming system according to claim 5, wherein the controller receives input of a control parameter from a user when the output result from the first output section is not reflected in the image formation.

8. The image forming system according to claim 3, wherein, when the output result from the first output section is not reflected, the controller refers to a sheet usage record database, selects usage history data on the basis of a degree of matching with the sheet characteristic information that has been detected, and sets a control parameter for the image formation using a control parameter stored in the selected usage history data.

9. The image forming system according to claim 8, wherein the controller receives input of a control parameter from a user when the degree of matching is equal to or less than a predetermined value.

10. The image forming system according to claim 1, wherein the accuracy output from the second output section is notified to a user.

11. The image forming system according to claim 1, wherein the second output section is a training model that outputs the accuracy when receiving, as an input, the sheet characteristic information that has been detected,
the training model is trained using a data set that includes the sheet characteristic information as training data and information indicating whether or not a quality failure occurs as a ground truth label, and outputs reliability of not generating a quality failure as the accuracy, and
the quality failure of the data set is a determination result of at least one of conveyance quality and image quality when image formation is performed on the basis of the output result from the first output section based on the sheet characteristic information.

12. The image forming system according to claim 11, wherein the conveyance quality is information regarding an occurrence of a conveyance jam during image formation.

13. The image forming system according to claim 11, wherein the image quality is assessed by analyzing read data obtained by reading a sheet on which an image is formed.

14. The image forming system according to claim 11, wherein the training data includes data collected from a plurality of the image forming systems.

15. A control device comprising:
an acquirer that acquires sheet characteristic information corresponding to a characteristic of a sheet, the sheet characteristic information being detected by a detector;
a first output section that outputs at least one of an attribute of the sheet and a control parameter for forming an image on the sheet on the basis of the sheet characteristic information that has been detected; and
a second output section that outputs accuracy for reliability of an output result from the first output section on the basis of the sheet characteristic information that has been acquired.

16. The control device according to claim 15, further comprising a controller that determines, based on the accuracy output from the second output section, whether to use the output result from the first output section.

17. A computer-readable recording medium storing a control program for causing a computer to execute processing comprising:
a step (a) of acquiring sheet characteristic information corresponding to a characteristic of a sheet detected by a detector;
a step (b) of outputting at least one of an attribute of the sheet and a control parameter for forming an image on the sheet on the basis of the sheet characteristic information acquired in the step (a); and
a step (c) of outputting accuracy for reliability of an output result in the step (b) on the basis of the sheet characteristic information acquired in the step (a).

18. The computer-readable recording medium storing the control program according to claim 17, wherein the processing further comprises a step (d) of determining, based on the accuracy output in the step (c), whether to use the output result in the step (b).
